(19) United States
(12) Patent Application Publication
(10) Pub. No.: US 2019/0148969 A1
(43) Pub. Date: May 16, 2019

(54) METHOD AND APPARATUS FOR WIRELESS CHARGING OF A MOBILE DEVICE

(71) Applicant: Metawave Corporation, Palo Alto, CA (US)

(72) Inventors: Bernard Casse, Palo Alto, CA (US); Maha Achour, Palo Alto, CA (US)

(73) Assignee: Metawave Corporation, Palo Alto, CA (US)

(21) Appl. No.: 16/192,554

(22) Filed: Nov. 15, 2018

Related U.S. Application Data
(60) Provisional application No. 62/586,647, filed on Nov. 15, 2017.

(51) Int. Cl. H02J 7/02; H02J 50/80; H02J 50/20

(52) U.S. Cl. CPC H02J 7/025; H01Q 1/364; H02J 50/20; H02J 50/80

(57) ABSTRACT

Examples disclosed herein relate to a Wireless Charging Unit (“WCU”) for charging a mobile device. The WCU has a beacon control module to receive a power request from the mobile device and transmit the power request to a transmission hub, a metastructure antenna having an array of cells to receive an RF signal from the transmission hub in response to the power request from the mobile device, and a storage and charge transfer module to store energy from the RF signal for transferring to the mobile device for charging.

### CROSS-REFERENCE TO RELATED APPLICATIONS

This application claims priority to U.S. Provisional Application No. 62/586,647, filed on Nov. 15, 2017, and incorporated herein by reference.

### BACKGROUND

Mobile devices are often limited by the ability to store charge necessary for operation. Most devices require wired connection to a power source, such as an electrical outlet. Each device includes a battery, and the battery life is a function of the storage capability of the battery, the battery quality and age, and the usage behavior of the user. Charging the device often requires its user to have a portable charger and a cable compatible with the device's charging interface. Running out of power is problematic and frustrating for device users when the right portable charger is not readily available.

### BRIEF DESCRIPTION OF THE DRAWINGS

The present application may be more fully appreciated in connection with the following detailed description taken in conjunction with the accompanying drawings, which are not drawn to scale and in which like reference characters refer to like parts throughout, and wherein:

FIG. 1 is a schematic diagram of a wireless system in accordance with various examples;

FIG. 2 illustrates signal flow between a mobile device and a wireless transmission hub in accordance with various examples;

FIG. 3 is a schematic diagram of a wireless charging unit in accordance with various examples;

FIG. 4 illustrates a wireless charging unit and a user equipment in accordance with various examples;

FIG. 5 illustrates a metastructure antenna for use in a wireless charging unit in accordance with various examples;

FIG. 6 illustrates an example multi-layer metastructure antenna for use in a wireless charging unit; and

FIG. 7 is a cross-sectional view of a wireless charging unit structure in accordance with various examples.

### DETAILED DESCRIPTION

Methods and apparatuses for wireless charging of a mobile device are disclosed. The mobile device, generally referred to herein as a User Equipment (“UE”), is charged wirelessly from wireless signals received thereon. A wireless charging unit having a metastructure antenna capable of manipulating electromagnetic waves is able to efficiently store and transmit power wirelessly to the UE.

It is appreciated that, in the following description, numerous specific details are set forth to provide a thorough understanding of the examples. However, it is appreciated that the examples may be practiced without limitation to these specific details. In other instances, well-known methods and structures may not be described in detail to avoid unnecessarily obscuring the description of the examples. Also, the examples may be used in combination with each other.

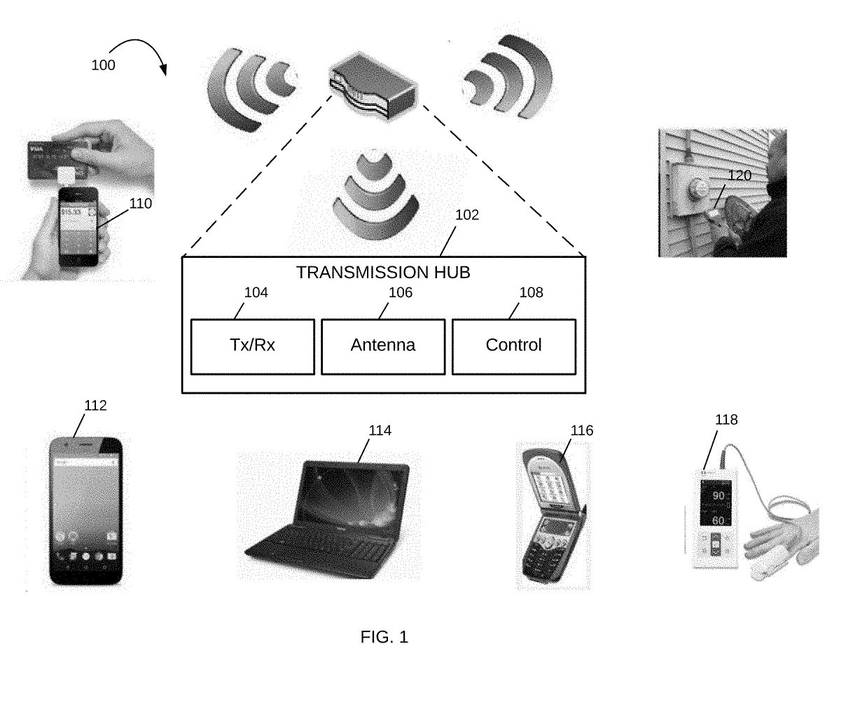

FIG. 1 illustrates a wireless system 100, having a transmission hub 102, such as a cellular base station, Wi-Fi control point or other wireless distribution apparatus. The transmission hub 102 includes a transceiver unit 104, an antenna 106 and a control 108. In various examples, the transmission hub 102 operates to transmit signals to and receive signals from multiple mobile devices, such as, for example, UE 110 to UE 120, including mobile payment or point of sale device 110, smart phone 112, laptop 114, flip phone 116, medical monitor device 118 and energy usage meter 120. The transmission hub 102 is configured to also transmit signals to one or more UEs for power charging. When a UE has power below a power threshold, the UE sends a signal to the transmission hub 102 through a Wireless Charging Unit (“WCU”), not shown, which sends a power request to the transmission hub 102. The control 108 determines when a connection is to be made to a specific UE, and sets up the transmission parameters to facilitate the transmission. This transmission may be an informational transmission, a call to the UE, or may be a power transmission signal.

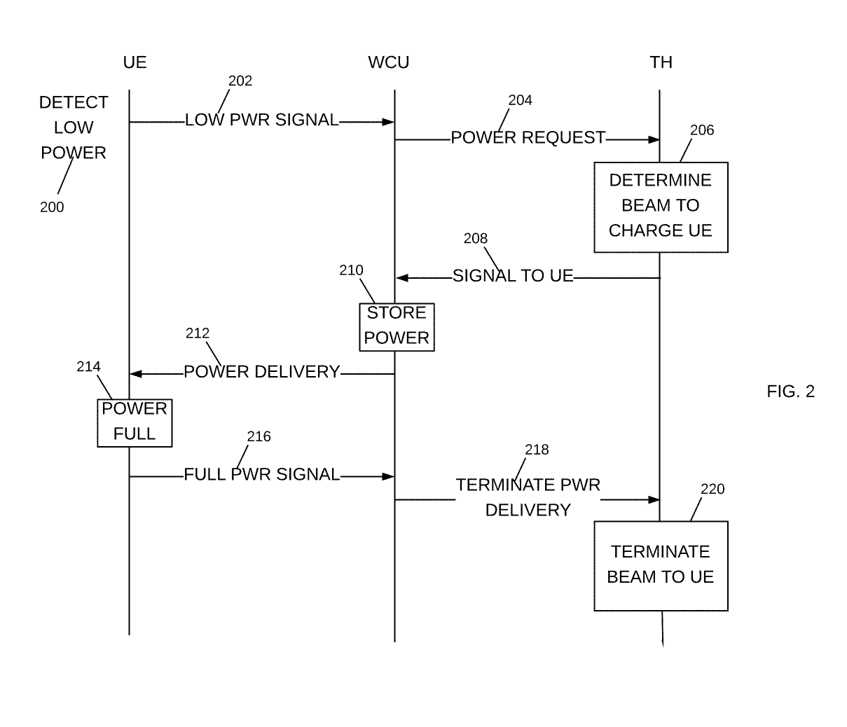

FIG. 2 illustrates a signal flow diagram of power charging a UE. First, a UE detects a power level below a power threshold (200) and sends a low power signal to its WCU (202). The WCU may be incorporated into the UE or may be a separate device from the UE. The WCU transmits the power request to the transmission hub, “TH” (204). The hub configures a transmission signal and radiation beam to charge the UE (206). The signal is transmitted to the WCU (208), where its energy is stored at the WCU (210). The stored energy is then provided to the UE (212). When sufficient power is received (214), the UE sends a full power signal indication to the WCU (216), which then sends a signal to the TH to terminate power delivery (218). Once the UE is fully charged, the TH terminates its transmission signal (220).

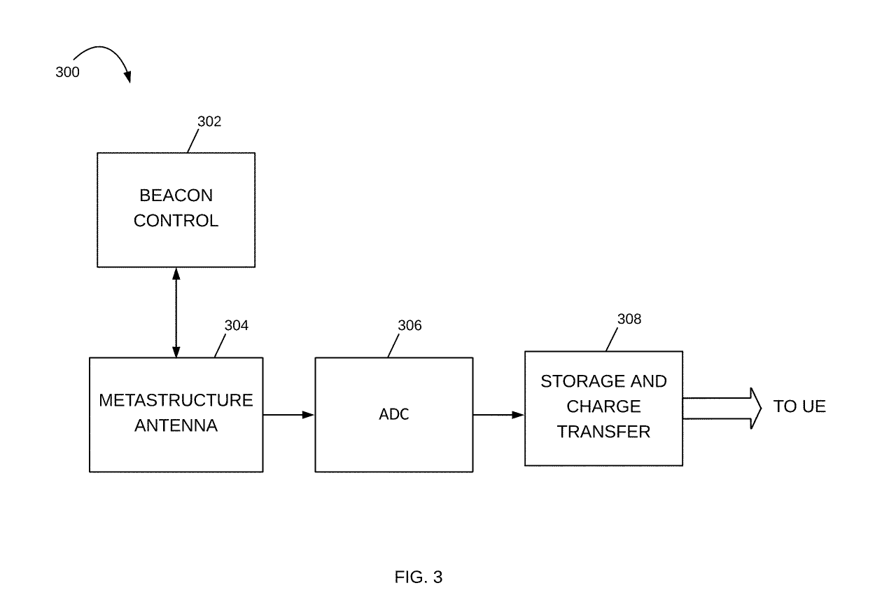

A schematic diagram of a WCU in accordance with various examples is shown in FIG. 3. WCU 300 has a beacon control module 302 that receives a power request from a UE (202) and sends it (204) to the TH (not shown). The WCU 300 includes a metastructure antenna 304, an Analog-to-Digital Converter (“ADC”) 306 and a storage and charge transfer module 308. When an RF signal is received from the TH at metastructure antenna 304, the signal is converted into a digital signal and its energy is stored at the storage and charge transfer module 308. The stored energy is then transferred from WCU 300 to the UE (not shown).

The metastructure antenna 304 is a high directivity, high gain antenna based on a metastructure, which as generally defined herein, is an engineered structure capable of controlling and manipulating incident radiation (in this case, incident radiation from the TH) at a desired direction based on its geometry. The metastructure antenna 304, described in more detail below, enables WCU 300 to reduce its signal conditioning burden when receiving the wireless signal from the TH as it is capable of receiving RF beams in multiple directions at a high gain and increased performance. Further, the metastructure antenna 304 is capable of receiving the wireless signal from the TH efficiently thereby increasing signal strength when it is converted into a digital signal by the ADC 306 and enabling WCU 300 to have higher efficiency and power delivery to the UE.

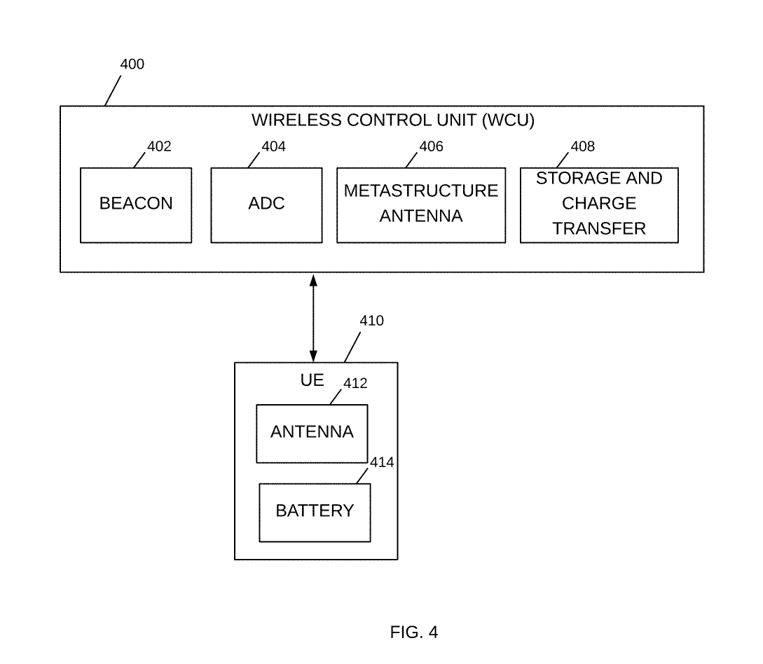

FIG. 4 illustrates a wireless charging unit and a user equipment in accordance with various example. WCU 400 has a metastructure antenna 406 that acquires power from wireless signals and stores that information in battery 414 of UE 410. In the illustrated example, the WCU 400 includes a beacon 402 and a storage and charge transfer module 408. When the WCU 400 charges the UE 410, the received signal is provided from metastructure antenna 406 to UE 50. The configuration 40 may be enclosed in a single unit, or WCU 42 may be separate from UE 410 via the storage and transfer module 408. The beacon 402 controls a signal sent to a wireless transmission source to identify the WCU 400. Once the WCU 400 requests power transmissions from a TH (not shown), the metastructure antenna 406 receives the signal energy. In various examples and as described below, the metastructure antenna 406 is an array of cells that are configured to transmit and/or receive RF signals at a high directivity and gain. By providing a signal to the TH, the WCU 400 indicates its position. The TH may then use a directed beam to send power to the WCU 400. In this way, the wireless system 100 operates most efficiently and is able to achieve a balance between the bandwidth capabilities of WCU 400 and the energy transfer.

The WCU 400 may be specific to a type of wireless signal, or may be adapted to acquire power from one of multiple wireless signals, such as cellular, Wi-Fi, Bluetooth and so forth. Each group or subarray of cells is responsive to a specific bandwidth of frequencies. In some examples, WCU 400 provides energy fluence, or energy through a metastructure antenna 406 with multi-frequency capabilities. Subarrays within the metastructure antenna 406 can respond to different frequencies, wherein a first sub array responds to a first frequency, and a second sub array responds to a second frequency. The subarrays may perform better at different conditions, enabling the WCU 400 to adapt its performance efficiently in different applications and scenarios.

The signals received from a TH, such as TH 102 in FIG. 1, may be cellular, Wi-Fi or other wireless signals. The TH may include any number of other functional units, such as a GPS system. As a user moves away from a transmission area of TH, WCU 400 coupled to UE 410 will send a beacon signal to identify a nearby TH, and is then able to continue the power charging from another TH.

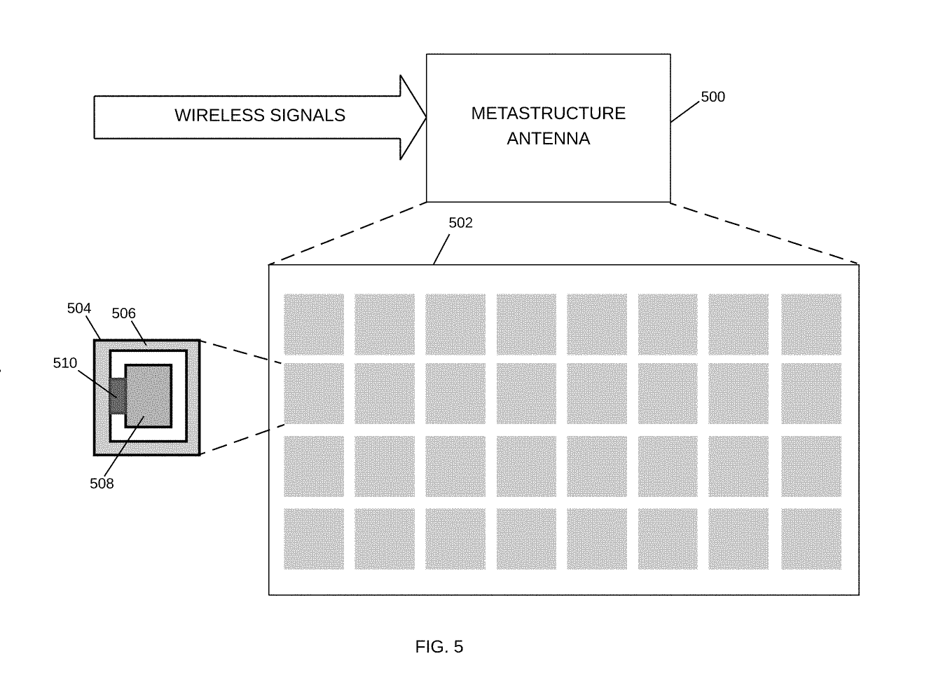

Attention is now directed to FIG. 5, which illustrates a metastructure antenna for use in a wireless charging unit in accordance with various examples. Metastructure antenna 500 has an array of cells 502. As illustrated, the cells 502 are uniform structures, which are designed to acquire power of a first bandwidth of frequencies, such as Wi-Fi frequencies. Alternate examples may be configured to respond to multiple frequency bands. In one example, the array of cells may include different size and/or shape cells to respond to multiple frequencies.

In one example, each cell 502 may be a metamaterial (“MTM”) cell. An MTM cell is an artificially structured element used to control and manipulate physical phenomena, such as the electromagnetic properties of a signal including its amplitude, phase, and wavelength. Metamaterial cells behave as derived from inherent properties of their constituent materials, as well as from the geometrical arrangement of these materials with size and spacing that are much smaller relative to the scale of spatial variation of typical applications. A metamaterial is a geometric design of a material, such as a conductor, wherein the shape creates a unique behavior for the device. An MTM cell may be composed of multiple microstrips, gaps, patches, vias, and so forth having a behavior that is the equivalent to a reactance element, such as a combination of series capacitors and shunt inductors. Various configurations, shapes, designs and dimensions are used to implement specific designs and meet specific constraints. In some examples, the number of dimensional degrees of freedom determines the characteristics, wherein a cell having a number of edges and discontinuities may model a specific-type of electrical circuit and behave in a given manner. In this way, an MTM cell radiates according to its configuration. Changes to the reactance parameters of the MTM cell result in changes to its radiation pattern. Where the radiation pattern is changed to achieve a phase change or phase shift, the resultant structure is a powerful antenna, as small changes to the MTM cell can result in large changes to the beamform. The array of cells 502 is configured so as to form a composite beamform. This may involve subarrays of the cells or the entire array.

The MTM cells 502 may include a variety of conductive structures and patterns, such that a received transmission signal is radiated therefrom. In some examples, each MTM cell may have unique properties. These properties may include a negative permittivity and permeability resulting in a negative refractive index; these structures are commonly referred to as left-handed materials (“LHM”). The use of LHM enables behavior not achieved in classical structures and materials, including interesting effects that may be observed in the propagation of electromagnetic waves, or transmission signals. Metamaterials can be used for several interesting devices in microwave and terahertz engineering such as antennas, sensors, matching networks, and reflectors, such as in telecommunications, automotive and vehicular, robotic, biomedical, satellite and other applications. For antennas, metamaterials may be built at scales much smaller than the wavelengths of transmission signals radiated by the metamaterial. Metamaterial properties come from the engineered and designed structures rather than from the base material forming the structures. Precise shape, dimensions, geometry, size, orientation, arrangement and so forth result in the smart properties capable of manipulating electromagnetic waves by blocking, absorbing, enhancing, or bending waves.

In some examples, at least one of the MTM cells is coupled to a reactance control mechanism, such as a varactor to change the capacitance and/or other parameters of the MTM cell. By changing a parameter of the MTM cell, the resonant frequency is changed, and therefore, the array 502 may be configured and controlled to respond to multiple frequency bands. An example of such a cell is illustrated as MTM cell 504. MTM cell 504 has a conductive outer portion or loop 506 surrounding a conductive area 508 with a space in between. Each MTM cell 504 may be configured on a dielectric layer, with the conductive areas and loops provided around and between different MTM cells. A voltage controlled variable reactance device 510, e.g., a varactor, provides a controlled reactance between the conductive area 506 and the conductive loop 508. The controlled reactance is controlled by an applied voltage, such as an applied reverse bias voltage in the case of a varactor. The change in reactance changes the behavior of the MTM cell 504, enabling the array 502 to receive beams at a high directivity and gain.

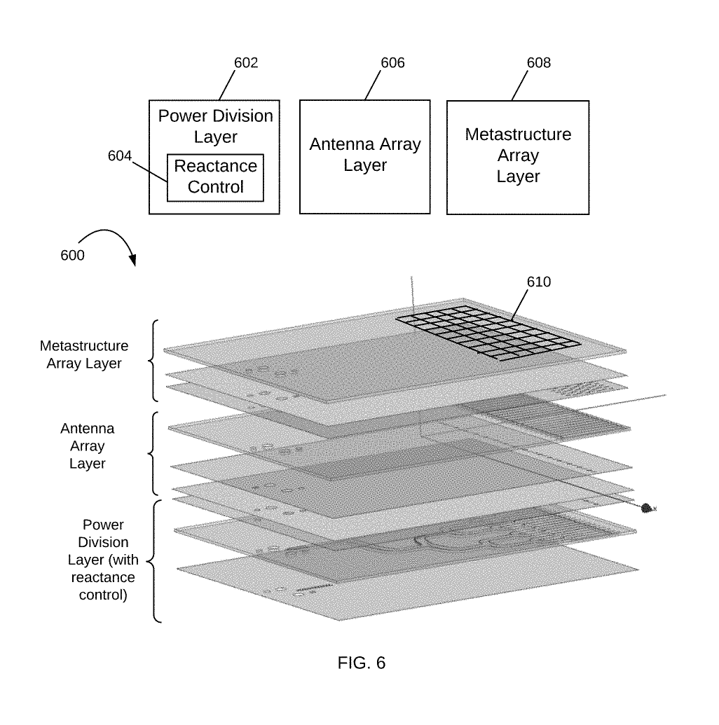

It is appreciated that additional circuits, modules and layers may be integrated with the array 502 in metastructure antenna 500. Metastructure antenna 500 may include a power division or feed layer with reactance control RFICs, and a radiating/antenna layer coupled to the array 502. FIG. 6 illustrates an example multi-layer metastructure antenna 600 having a power division layer 602 with reactance control 604, an antenna array layer 606 and a metastructure array layer 608. The power division layer 602 divides a transmission signal for transmission into multiple transmission lines at antenna array layer 606. The antenna array layer 606 radiates the transmission signal to the metastructure array layer 608 having an array of cells 610 that provides high directivity and gain. The antenna 600 can serve as a transmit antenna to generate high gain narrow beams at multiple directions, or the antenna 600 can serve as a receive antenna to receive beams from multiple directions. In some configurations, the antenna 600 may be adapted for both transmit and receive.

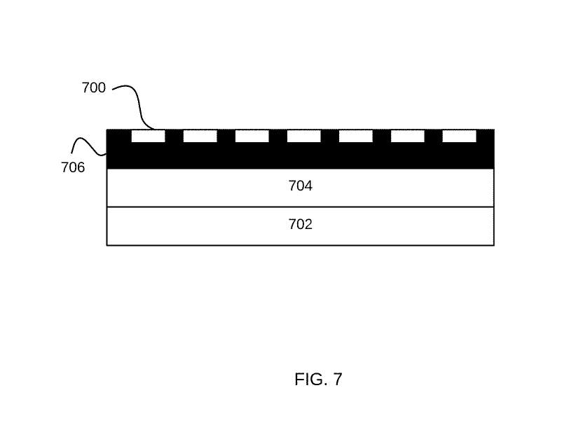

FIG. 7 illustrates a cross-sectional view of a portion of a wireless charging unit in accordance with various examples. The structure is built on a conductive reference layer 702. The metastructure cells 700 are positioned within another conductive layer 706. A lossy material layer 704 is positioned between conductive layers 702 and 706. A variety of materials may be used to achieve wireless charging of a mobile device on receipt of wireless transmission signals. Note that the illustrated structure is just an example and other configurations may be used for a metastructure antenna in a WCU, such as the multi-layer structure of FIG. 6. The metastructure antennas described hereinabove are particularly applicable for directed beam generation in a wireless transmission device.

This directivity may be used to improve the capability of a WCU to charge a device, wherein the transmission hub, base station, access point, and so forth, are able to direct wireless signals to a specific mobile device in response to a charge request. In some examples, the charging may operate in coordination with communication to the mobile device, such as illustrated in FIG. 2 with communication messages between the WCU and the mobile device. Messages from the mobile device to the WCU may include an indicator from the UE to request power charging from the WCU, which may indicate the type of transmission signal desired, such as a particular frequency or modulation. The WCU may provide messaging to the UE, or may just act as a slave device, providing transmissions for power charging until instructed to stop. The metastructure antennas are applicable to WCUs for a wide variety of mobile devices, as the power requirements are provided by wireless signals that are available, or even as requested. This provides users with extended life and convenient power charging.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A Wireless Charging Unit (“WCU”) for charging a mobile device, the WCU comprising:
a beacon control module to receive a power request from the mobile device and transmit the power request to a transmission hub;
a metastructure antenna comprising an array of cells to receive an RF signal from the transmission hub in response to the power request from the mobile device; and
a storage and charge transfer module to store energy from the RF signal for transferring to the mobile device for charging.

2. The WCU of claim 1, further comprising an analog-to-digital converter to convert the RF signal received by the metastructure antenna into a digital signal and transmit the digital signal to the storage and charge transfer module.

3. The WCU of claim 1, wherein the beacon control module is configured to identify the WCU.

4. The WCU of claim 1, wherein the cells comprise metamaterial cells.

5. The WCU of claim 4, wherein at least one of the metamaterial cells comprises a reactance control mechanism.

6. The WCU of claim 5, wherein the reactance control mechanism is a varactor coupled between a conductive area and a conductive loop in the at least one metamaterial cell.

7. The WCU of claim 1, wherein the array of cells comprises a plurality of subarrays, each subarray to respond to a set of frequencies.

8. The WCU of claim 1, wherein the metastructure antenna is a multi-layer metastructure antenna comprising a power division layer, an antenna array layer and a metastructure array layer.

9. The WCU of claim 8, wherein the antenna array layer comprises a plurality of transmission lines coupled to the power division layer.

10. A method for wireless charging of a mobile device, comprising:
receiving a low power signal from the mobile device;
transmitting a power request to a transmission hub;
receiving an RF signal from the transmission hub at a metastructure antenna in a wireless charging unit;
storing energy from the received RF signal; and
wirelessly transferring the stored energy to the mobile device for charging.

11. The method of claim 10, further comprising detecting a low power level at the mobile device.

12. The method of claim 10, further comprising configuring the RF signal at the transmission hub to charge the mobile device.

13. The method of claim 10, further comprising converting the received RF signal into a digital signal for storage.

14. The method of claim 10, further comprising indicating to the wireless charging unit that the mobile device has full power.

15. The method of claim 11, further comprising indicating to the transmission hub to terminate delivery of the RF signal.

16. The method of claim 10, further comprising configuring the metastructure into a plurality of subarrays, each subarray responding to a set of frequencies.

17. A wireless charging unit, comprising:
a multi-layer metastructure antenna adapted to receive energy from a transmission signal, the multi-layer metastructure antenna configured on a substrate comprising:
a conductive layer; and
a lossy dielectric layer coupled to the conductive layer, wherein the lossy dielectric layer absorbs energy from the transmission signal received at the metastructure antenna; and
a storage and charge transfer module for transferring the energy to a mobile device.

18. The wireless charging unit of claim 17, wherein the multi-layer metastructure antenna comprises a power division layer, an antenna array layer and a metastructure array layer.

19. The wireless charging unit of claim 18, wherein the metastructure array layer comprises an array of cells configured into a plurality of subarrays, each subarray to respond to a set of frequencies.

20. The wireless charging unit of claim 19, wherein the cells comprise metamaterial cells and at least one of the metamaterial cells comprises a reactance control mechanism.
